(19) United States
(12) Patent Application Publication
(10) Pub. No.: US 2012/0219688 A1
(43) Pub. Date: Aug. 30, 2012

(54) CONVEYOR OVEN AND METHOD FOR IMPROVING ENERGY EFFICIENCY

(75) Inventors: James R. BARNES, Huntington, IN (US); George CSADENYI, Fort Wayne, IN (US); Josh GALENTINE, Hoagland, IN (US); David L. FURGE, Fort Wayne, IN (US); Craig OECHSLE, Leo, IN (US); Jim C. WEST, Fort Wayne, IN (US); P. Andrew TYLER, Roanoke, IN (US)

(73) Assignees: CLEVELAND RANGE, LLC.; LINCOLN FOODSERVICE PRODUCTS LLC

(21) Appl. No.: 13/362,769

(22) Filed: Jan. 31, 2012

Related U.S. Application Data
(60) Provisional application No. 61/438,177, filed on Jan. 31, 2011.

(51) Int. Cl. A47J 37/00; F24C 15/02; A23L 1/01; A21B 1/48

(52) U.S. Cl. 426/523; 99/443 C; 126/21 A; 126/198

(57) ABSTRACT

A conveyor oven that preheats air for a combustion burner. A heat exchanger extracts heat from a heated surface of the oven to preheat the air. In one embodiment, the heated surface is a surface of a door and/or of a wall, particularly, a side wall that includes either an inlet or an outlet for the conveyor oven.

### RELATED APPLICATION

This application claims priority of U.S. Provisional Application Ser. No. 61/438,177, filed on Jan. 31, 2011, the entire contents of which are hereby incorporated by reference.

### BACKGROUND

1. Field of the Disclosure

The present disclosure relates to a conveyor oven and method for improving energy efficiency by preheating combustion air.

2. Description of Related Art

Conventional gas conveyor ovens are comprised of one or more combustion burners that draw free air from the ambient environment in order to maintain proper combustion levels of the system. Ordinarily, air being pulled into the combustion burner for this purpose is at ambient room temperatures, or only slightly above the ambient temperature. Thus, conventional conveyor ovens require the burner to supply the appropriate amount of energy to raise the temperature of the air from the initial free air temperature to a level, which allows the oven to reach the temperature set point. This leads to additional energy requirements to maintain the oven at a given temperature set point.

In addition, certain regions of the exterior surface of conventional conveyor ovens may have temperatures that pose hazardous conditions to users. In particular, the area above the inlet and outlet ports of the conveyor oven has raised surface temperatures due to energy transfer from both conductive heat transfer from interior surfaces to the exterior surface and from the convective transfer from hot air exiting along the exterior surface. The convective transfer is most prevalent in gas ovens. In some conventional gas ovens, additional areas may have elevated temperatures due to conduction of heat from interior zones to the exterior of the oven.

Accordingly, there is a need for a conveyor oven to effectively reduce the energy requirements of the system. Furthermore, there is a need for a conveyor oven that can reduce the energy requirements by lowering the temperature of the exterior surfaces of the oven and by preheating the combustion air.

Thus, there is a need a conveyor oven having strategically channeled ductwork to facilitate optimal heat transfer from the exterior surfaces of the oven to preheat air to a gas heater assembly.

### SUMMARY OF THE DISCLOSURE

An embodiment of a conveyor oven of the present disclosure comprises a housing that comprises a plurality of surfaces and that defines an oven compartment that includes an opening. A conveyor assembly is disposed in the oven compartment to convey food products into or out of the oven compartment via the opening. A blower assembly provides an air stream to the food products in the oven compartment. A gas heater assembly comprises a burner blower to draw free air from ambient and a combustion burner that mixes gas with the free air from ambient to provide a flame to heat the air stream. The surfaces are heated due to the flame or the air stream. A heat exchanger is disposed to preheat the free air by a thermal transfer of heat from one or more of the surfaces.

In another embodiment of the conveyor oven of the present disclosure, the surfaces comprise internal surfaces and external surfaces of the housing. The thermal transfer of heat preheats the free air and simultaneously cools one or more of the external surfaces.

In another embodiment of the conveyor oven of the present disclosure, the housing further comprises a door that comprises one of the internal surfaces and one of the external surfaces with a space in-between. The free air is drawn through the space by the burner blower via one or more ports disposed in the door. The thermal transfer of heat preheats the free air and simultaneously cools the external surface of the door.

In another embodiment of the conveyor oven of the present disclosure, the housing further comprises a panel that comprises one of the internal surfaces and one of the external surfaces. The heat exchanger comprises a duct channel that is disposed in thermally conductive contact with the internal surface of the panel. The free air is drawn through the duct channel by the burner blower. The thermal transfer of heat preheats the free air and simultaneously cools the external surface of the panel.

In another embodiment of the conveyor oven of the present disclosure, the panel comprises the opening through which heated air escapes from the oven compartment and heats the external surface of the panel, which is being simultaneously cooled by the thermal transfer of heat.

In another embodiment of the conveyor oven of the present disclosure, the duct channel is in fluid communication with the burner blower and a port to ambient.

An embodiment a method according to the present disclosure concerns a conveyor oven that comprises a conveyor and a housing that includes a plurality of surfaces and that defines an oven compartment with an opening. The method comprises: (a) providing a conveyor assembly disposed in the oven compartment to convey food products into or out of the oven compartment via the opening; (b)

providing a blower assembly that provides an air stream in the conveyor oven to cook food products; (c) providing a gas heater assembly that comprises a burner blower to draw free air from ambient and a combustion burner that mixes gas and the free air from ambient to provide a flame to heat the airstream, wherein the surfaces are heated due to the flame or the air stream; and (d) providing a heat exchanger to preheat the free air by a thermal transfer of heat from one or more of the surfaces.

In another embodiment of the method of the present disclosure, the surfaces comprise internal surfaces and external surfaces of the housing. The thermal transfer of heat preheats the free air and simultaneously cools one or more of the external surfaces.

In another embodiment of the method of the present disclosure, the surfaces comprise internal surfaces and external surfaces of the housing. The thermal transfer of heat preheats the free air and simultaneously cools one or more of the external surfaces.

In another embodiment of the method of the present disclosure, the method further comprises providing the housing with a door that comprises one of the internal surfaces and one of the external surfaces with a space in-between. The free air is drawn through the space by the burner blower via one or more ports disposed in the door. The thermal transfer of heat preheats the free air and simultaneously cools the external surface of the door.

In another embodiment of the method of the present disclosure, the method further comprises: providing the housing with a panel that comprises one of the internal surfaces and one of the external surfaces; and providing the heat exchanger with a duct channel that is disposed in thermally conductive contact with the internal surface of the panel, wherein the free air is drawn through the duct channel by the burner blower, and wherein the thermal transfer of heat preheats the free air and simultaneously cools the external surface of the panel.

In another embodiment of the method of the present disclosure, the duct channel is in fluid communication with the burner blower and a port to ambient.

In another embodiment of the method of the present disclosure, the panel comprises the opening. The heated air escapes from the oven compartment through the opening and heats the external surface of the panel, which is being simultaneously cooled by the thermal transfer of heat.

### BRIEF DESCRIPTION OF THE DRAWINGS

Other and further benefits, advantages and features of the present disclosure will be understood by reference to the following specification in conjunction with the accompanying drawings, in which like reference characters denote like elements of structure and:

FIG. 1 is a side view of a conveyor oven of the present disclosure;

FIG. 2 is a front view of the conveyor oven of FIG. 1, with the door removed;

FIG. 3 is a side view of the conveyor oven of FIG. 1, with the right side wall removed;

FIG. 4 is a top view of the conveyor oven of FIG. 1;

FIG. 5 is an enlarged view of the conveyor oven of FIG. 3, with the door and inner wall removed;

FIG. 6 is a perspective view of the gas heater assembly of the conveyor oven of FIG. 1; and

FIG. 7 is a perspective view of a portion of the heat exchanger of the conveyor oven of FIG. 1.

### DETAILED DESCRIPTION OF THE PREFERRED EMBODIMENT

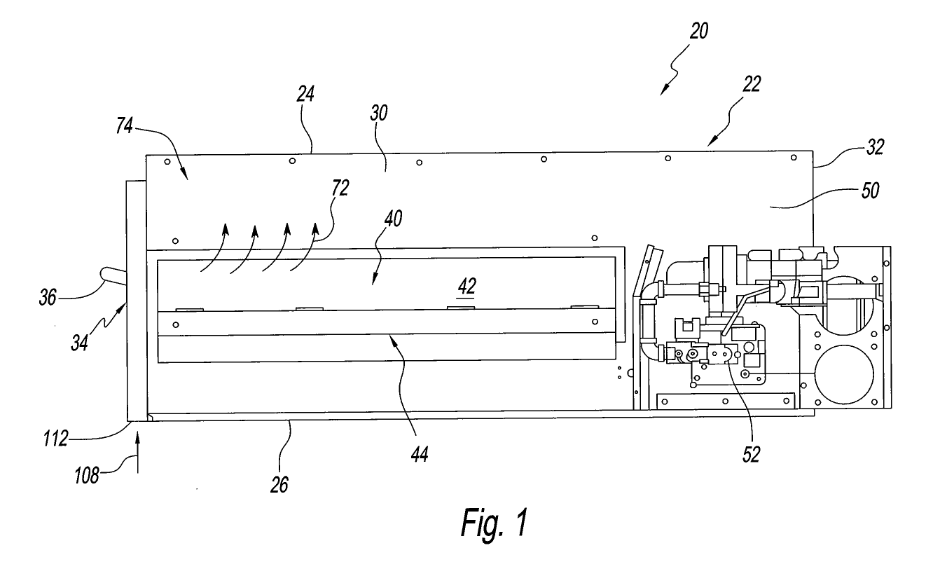

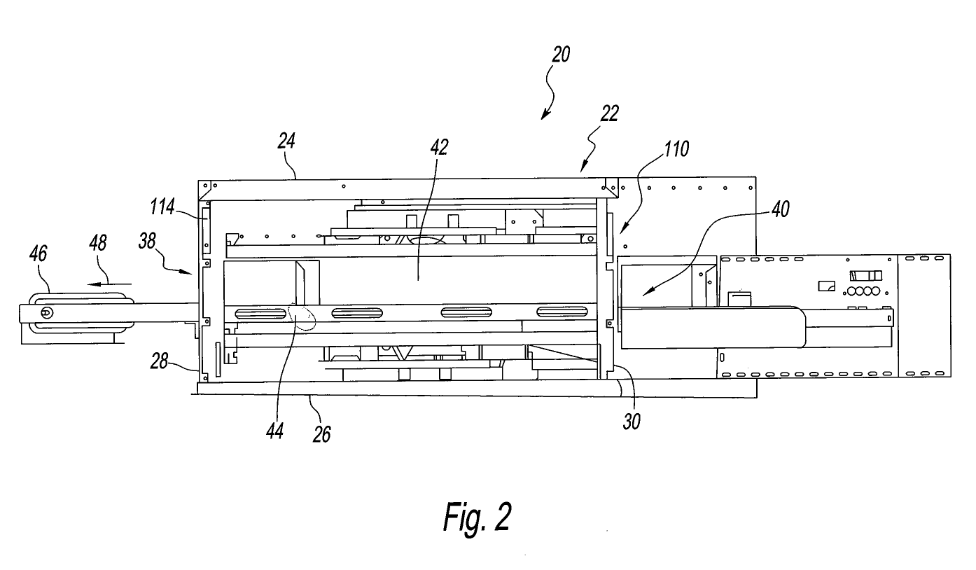

Referring to FIGS. 1 and 2, a conveyor oven 20 of the present disclosure comprises a housing 22 that comprises a top 24, a bottom 26, a left side wall 28, a right side wall 30, a back wall 32 and a door 34 that covers the front of conveyor oven 20. Door 34 has a handle 36 and is connected to housing 22 by a fastener (not shown) that allows door 34 to open by rotating, sliding, rolling and the like. For example, hinges may be used to provide opening by rotation up, down or to a side. Top 24, bottom 26, left side wall 28, right side wall 30, back wall 32 and door 34 and other members (not shown) of housing 22 comprise one or more surfaces that are either internal or external surfaces. For example, the inside and outside surfaces of right side wall 30 and door 34 are internal and external surfaces, respectively.

A left opening or outlet 38 is disposed in left side wall 28. A right opening or inlet 40 is disposed in right side wall 30. Housing 22 defines an oven chamber 42 disposed behind door 34 and between left and right side walls 28 and 30 and also defines a heating chamber 50 located between oven chamber 42 and back wall 32. A conveyor assembly 44 is disposed within oven chamber 42 and extends through and beyond outlet and inlet openings 38 and 40. A belt 46 of conveyor assembly 44 is driven by any suitable motive device and linkage to convey food through oven chamber 42 in a direction to enter via inlet opening 40 and exit via outlet opening 38 as shown by arrow 48 (FIG. 1). In other embodiments, belt 46 may be driven in the opposite direction, in which case the roles of outlet opening 38 and inlet opening 40 are reversed.

Referring to FIGS. 1, 2 and 4, oven chamber 42 comprises two cooking zones 56 and 58 for cooking food products disposed on belt 46. In other embodiments, oven chamber 22 may have only one cooking zone or more than two cooking zones. A ductwork for cooking zone 56 comprises a plurality of ducts including a duct 60 to provide a circulating airstream to cooking zone 56. A ductwork for cooking zone 58 comprises a plurality of ducts including a duct 62 to provide a circulating air stream to cooking zone 58. A blower 64 and a blower 66 are in fluid communication with duct 60 and duct 62, respectively, to provide and maintain the circulating air streams. A gas heater assembly 52 provides a flame 70 to heating chamber 50 to heat the circulating air stream to cooking zone 58. An identical gas heater assembly (not shown) provides a flame 68 to heating chamber 50 to heat the circulating air stream to cooking zone 56. It will be appreciated that ducts 60 and 62 provide convective airflow from above conveyor assembly 44, which in preferred embodiments is converted to impingement air. In other embodiments additional heat can be provided from below conveyor assembly 44 by heated circulating air streams and/or radiant heaters.

Although the ductworks for ducts 60 and 62 include return air passages for the circulating air streams, some of the heated air is deflected by and travels horizontally along conveyor assembly 44 toward and exits or escapes from outlet 38 and inlet 40. The exiting hot air bends upwardly along the regions of external surfaces of side walls 28 and 30, respectively, above outlet 38 and inlet 40. For example, in FIG. 1 arrows 72 show the exiting air path along a region 74 of the external surface of right side wall 30 that is above inlet 40. The exiting hot air convectively heats these regions of the external surfaces of left and right side walls 28 and 30 above outlet and inlet 38 and 40, respectively. Additionally, heat is transferred conductively from internal surfaces to the external surfaces of left and right side walls 28 and 30.

Since gas heater assembly 52 for cooking zone 58 and the gas heater assembly (not shown) for cooking zone 56 are identical, only gas heater assembly 52 will be described in detail. Referring to FIGS. 1, 2, 4 and 6, gas heater assembly 52 comprises a gas inlet 80, an On/Off gas valve 82, a modulating gas valve 84, a burner blower 86, an air inlet 88 and a combustion burner 90. Gas inlet 80 is connected to a gas supply line (not shown). Gas On/Off valve 82 is electrically controlled (e.g., by a solenoid) to allow or disallow gas flow. Modulating gas valve 84 is operable to smoothly control this flow of gas. Burner blower 86 is operable to draw free air from ambient to gas heater assembly 52 via air inlet 88. The free air from ambient and gas are mixed in combustion burner 90 to provide flame 70 to heating chamber 50.

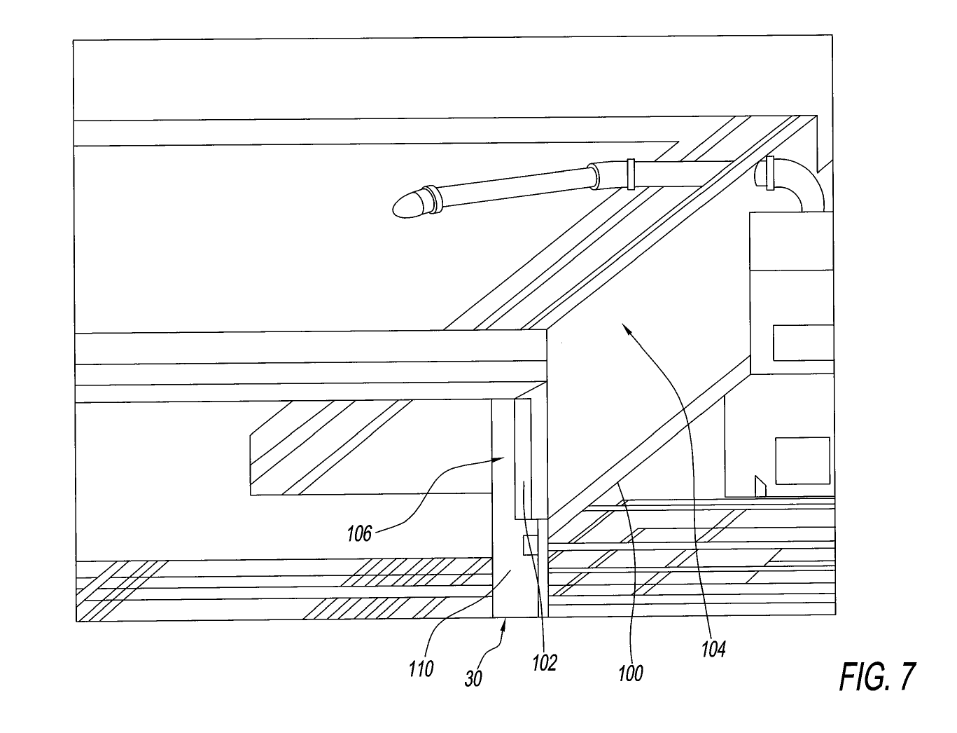

Referring to FIG. 7, a heat exchanger 100 is disposed to preheat free air drawn from ambient to air inlet 88 of gas heater assembly 52 and simultaneously cool an exterior surface or surfaces of conveyor oven 20. Heat exchanger 100 is strategically channeled in a manner to pull potential system heat losses from exterior surfaces of conveyor oven 20, which are above the ambient temperature of the free air from ambient via a convective heat transfer process. In particular, heat exchanger 100 is constructed in a manner that pre-heats the free air for gas heater assembly 52 so as to effectively reduce the energy requirements of conveyor oven 20 while simultaneously lowering the temperature of exterior surfaces (e.g., the exterior surface of right side wall 30) of conveyor oven 20.

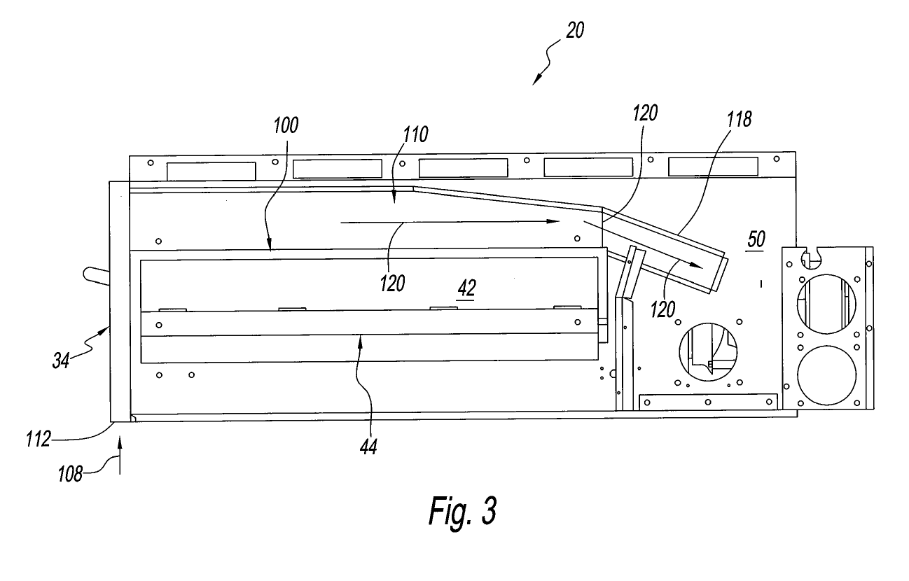

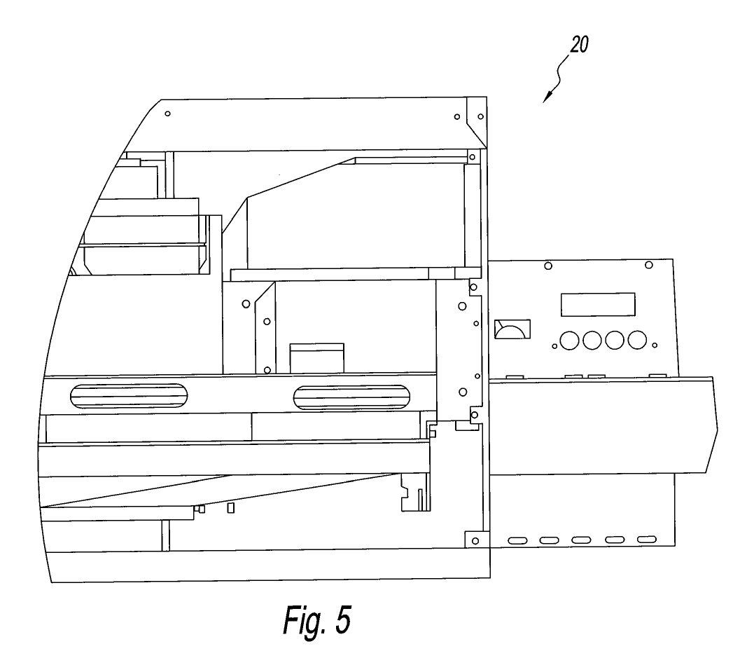

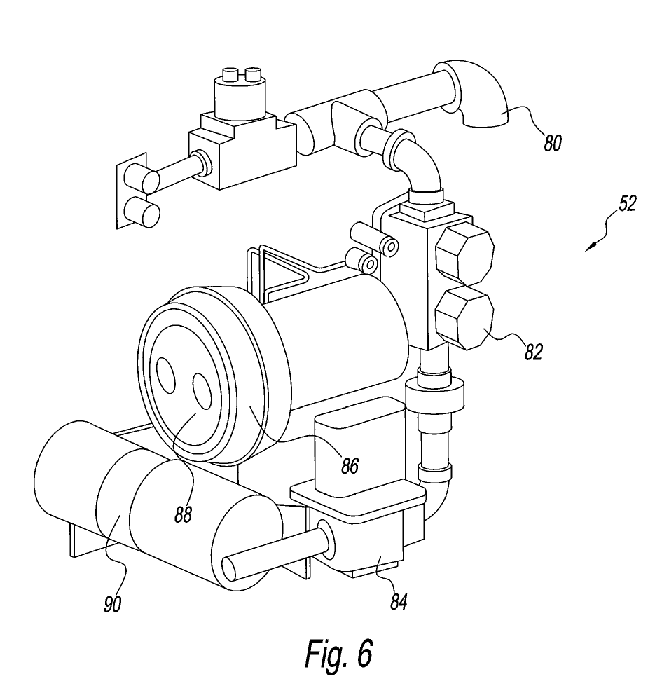

Referring to FIGS. 1 and 3-7, heat exchanger 100 comprises ductwork 102 (FIG. 7) that channels airflow from ambient shown by arrow 108 in FIGS. 1 and 3 via door 34 through a duct channel 110 shown in FIGS. 3, 4 and 7 to air inlet 88 of gas heater assembly 52 in FIG. 6. The free air ambient is drawn through ductwork 102 by burner blower 86 shown in FIG. 6.

Ductwork 102 is channeled from (in fluid communication with) an ambient air port or ports 112 located along a bottom edge of door 34 (shown in FIGS. 1 and 3) through door 34 which has an interior surface in contact with the front edges of conveyor oven 20. These front edges have been heated above ambient due to conduction from the interior surfaces of conveyor oven 20 to its exterior surfaces. The free air being drawn through door 34 is conductively heated by heat transfer from these front edges via an interior surface of door 34, while simultaneously cooling the front edges of conveyor oven 20 and door 34 as well. It will be appreciated by those of skill in the art that ports 112 can be at alternate locations that provide a path for air to flow along the edges of door 34 or another portion of conveyor oven 20.

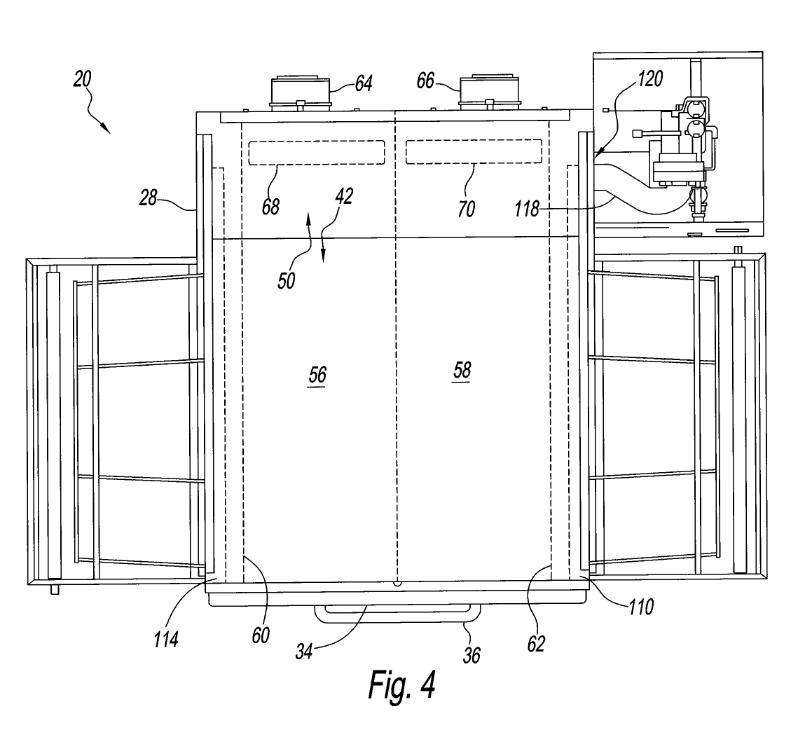

Referring to FIGS. 2-4 and 7, the free air is also heated by conductive heat or thermal transfer via duct channel 110. Duct channel 110 is disposed between an interior wall or panel 106 and an exterior wall or panel 104 of right side wall 30 as shown in FIGS. 4 and 7. In particular, duct channel 110 is in physical contact with an interior surface of exterior wall 104 to enhance the conductive transfer of heat to the airflow, while simultaneously cooling exterior wall 104. An end of duct channel 110 that interfaces to door 34 is shown in FIG. 2.

Duct channel 110 is shaped to maximize contact with region 74 above opening 40 in right side wall 30 as shown in FIGS. 1, 3 and 8. Duct channel 110 is sloped to change its shape to match with an interface 120. A flexible tubing 118 connects interface 120 to air inlet 88 of gas heater assembly 52 to provide a fluid communication of duct channel 110 burner blower 86. The air flow in duct channel 110 is depicted by arrows 120 in FIG. 3. A similar duct channel 114 is located along left side wall 28 in fluid communication with air flow about one or more edges of door 34 and the associated gas heater assembly (not shown) for combustion burner 68.

The present disclosure having been thus described with particular reference to the preferred forms thereof, it will be obvious that various changes and modifications may be made therein without departing from the spirit and scope of the present disclosure as defined in the appended claims.

What is claimed is:

1. A conveyor oven comprising:
a housing that comprises a plurality of surfaces and that defines an oven compartment that includes an opening;
a conveyor assembly disposed in said oven compartment to convey food products into or out of said oven compartment via said opening;
a blower assembly that provides an air stream to said food products in said oven compartment;
a gas heater assembly that comprises a burner blower to draw free air from ambient and a combustion burner that mixes gas with said free air from ambient to provide a flame to heat said air stream , wherein said surfaces are heated due to said flame or said air stream; and
a heat exchanger disposed to preheat said free air by a thermal transfer of heat from one or more of said surfaces.

2. The conveyor oven of claim 1, wherein said surfaces comprise internal surfaces and external surfaces of said housing, and wherein said thermal transfer of heat preheats said free air and simultaneously cools one or more of said external surfaces.

3. The conveyor oven of claim 2, wherein said housing further comprises a door that comprises one of said internal surfaces and one of said external surfaces with a space in-between, wherein said free air is drawn through said space by said burner blower via one or more ports disposed in said door, and wherein said thermal transfer of heat preheats said free air and simultaneously cools said external surface of said door.

4. The conveyor oven of claim 2, wherein said housing further comprises a panel that comprises one of said internal surfaces and one of said external surfaces, wherein said heat exchanger comprises a duct channel that is disposed in thermally conductive contact with said internal surface of said panel, wherein said free air is drawn through said duct channel by said burner blower, and wherein said thermal transfer of heat preheats said free air and simultaneously cools said external surface of said panel.

5. The conveyor oven of claim 4, wherein said panel comprises said opening through which heated air escapes from said oven compartment and heats said external surface of said panel, which is being simultaneously cooled by said thermal transfer of heat.

6. The conveyor oven of claim 4, wherein said duct channel is in fluid communication with said burner blower and a port to ambient.

7. A method for a conveyor oven that comprises a conveyor and a housing that includes a plurality of surfaces and that defines an oven compartment with an opening, said method comprising:
providing a conveyor assembly disposed in said oven compartment to convey food products into or out of said oven compartment via said opening;
providing a blower assembly that provides an air stream in said conveyor oven to cook food products;
providing a gas heater assembly that comprises a burner blower to draw free air from ambient and a combustion burner that mixes gas and said free air from ambient to provide a flame to heat said airstream, wherein said surfaces are heated due to said flame or said air stream; and
providing a heat exchanger to preheat said free air by a thermal transfer of heat from one or more of said surfaces.

8. The method of claim 7, wherein said surfaces comprise internal surfaces and external surfaces of said housing, and wherein said thermal transfer of heat preheats said free air and simultaneously cools one or more of said external surfaces.

9. The method of claim 8, further comprising:
providing said housing with a door that comprises one of said internal surfaces and one of said external surfaces with a space in-between, wherein said free air is drawn through said space by said burner blower via one or more ports disposed in said door, and wherein said thermal transfer of heat preheats said free air and simultaneously cools said external surface of said door.

10. The method of claim 7, further comprising:
providing said housing with a panel that comprises one of said internal surfaces and one of said external surfaces; and
providing said heat exchanger with a duct channel that is disposed in thermally conductive contact with said internal surface of said panel, wherein said free air is drawn through said duct channel by said burner blower, and wherein said thermal transfer of heat preheats said free air and simultaneously cools said external surface of said panel.

11. The method of claim 10, wherein said duct channel is in fluid communication with said burner blower and a port to ambient.

12. The method of claim 10, wherein said panel comprises said opening, wherein heated air escapes from said oven compartment through said opening and heats said external surface of said panel, which is being simultaneously cooled by said thermal transfer of heat.
